(19) United States
(12) Patent Application Publication
(10) Pub. No.: US 2015/0109345 A1
(43) Pub. Date: Apr. 23, 2015

(54) APPARATUS AND METHOD FOR CONTROLLING GRID OUTPUT IN A MOBILE DEVICE

(71) Applicant: TOBESOFT CO.,LTD., Seoul (KR)

(72) Inventors: Hwajun Song, Seoul (KR); Woocheol Lee, Seoul (KR)

(21) Appl. No.: 14/507,850

(22) Filed: Oct. 7, 2014

(30) Foreign Application Priority Data
Oct. 18, 2013 (KR) 10-2013-0124809

(51) Int. Cl. G06T 3/20; G06T 11/20

(52) U.S. Cl. CPC G06T 3/20; G06T 11/206
USPC 345/672

(57) ABSTRACT

A method and apparatus for controlling a grid output in a mobile device are disclosed. The method includes changing contents displayed in at least one grid arranged in the at least one row moved to under the last of a plurality of rows displayed on the display or to above the first of the plurality of rows displayed on the display by a contents converter, and displaying the moved at least one row and the changed contents in the at least one grid arranged in the moved row on the display by a screen output unit.

### CROSS REFERENCE TO PRIOR APPLICATION

This application claims the benefit of Korean Patent Application No. 10-2013-0124809, filed on Oct. 18, 2013, which is hereby incorporated by reference as if fully set forth herein.

### BACKGROUND OF THE INVENTION

1. Field of the Invention

The present invention relates to an apparatus and method for controlling a grid output in a mobile device, and more particularly, to an apparatus and method for controlling a grid output in a mobile device, which can increase the speed of displaying grids on a display of the mobile device by moving a part of rows that have disappeared from the display among a plurality of rows forming the grids displayed on the mobile device during scrolling to under a last row displayed on the mobile device.

2. Discussion of the Related Art

Owing to reinforcement of network infrastructure, the increasing use of the Internet, and the development of mobile communication technology, communication service is available irrespective of time and place. Particularly, as mobile devices providing communication service, such as smartphones, have recently been developed, users can use a Web server by connecting to the Internet through their mobile devices at any time in any place.

Various types of information exist in Web servers on the Internet. For example, a Web server may have grid information in which various pieces of information are arranged. A mobile device may receive grid information along with information about a screen of the Web server, generate the screen and grids of the Web server, and display the generated screen and grids on a display unit.

Traditionally, a mobile device loads total rows and contents corresponding to respective grids arranged in the rows based on grid information received from a Web server, renders grids in a predetermined number of rows corresponding to the screen size of a display unit from among the loaded rows, and displays the rendered grids on the display unit. As the mobile device has a lower specification, it takes the mobile device a longer time to load total rows and contents corresponding to respective grids arranged in the rows. That is, a low-performance mobile device takes much time to load total rows and contents corresponding to grids arranged in the rows. As a result, a time to display the grids on a display unit is also increased. In this context, techniques for rapidly generating grids through a display unit even in a low-performance mobile device have recently been developed.

### SUMMARY OF THE INVENTION

Accordingly, the present invention is directed to an apparatus and method for controlling a grid output in a mobile device that substantially obviate one or more problems due to limitations and disadvantages of the related art.

An object of the present invention is to provide an apparatus and method for controlling a grid output in a mobile device, which can increase the speed of displaying grids of a Web server of the Internet on the mobile device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for controlling a grid output in a mobile device includes generating a plurality of rows for grids and displaying the generated plurality of rows on a display of the mobile device by a grid generator, displaying contents corresponding to each of at least one grid arranged in each of the plurality of rows in the grid by a contents output unit, sensing movement of a scroll bar, moving the plurality of rows and the contents displayed in each of the at least one grid arranged in the plurality of rows according to the sensed movement of the scroll bar, and moving at least one row that has disappeared from the display due to the movement of the plurality of rows to under a last of a plurality of rows displayed on the display or to above a first of the plurality of rows displayed on the display by a grid mover, changing contents displayed in at least one grid arranged in the at least one row moved to under the last of a plurality of rows displayed on the display or to above the first of the plurality of rows displayed on the display by a contents converter, and displaying the moved at least one row and the changed contents in the at least one grid arranged in the moved row on the display by a screen output unit.

The changing of contents may include determining whether the contents displayed in the at least one grid arranged in the moved at least one row are identical to contents to be displayed in the at least one grid arranged in the moved at least one row, and maintaining the contents displayed in the at least one grid arranged in the moved at least one row, if the displayed contents are identical to the contents to be displayed.

The changing of contents may further include changing only contents corresponding to a difference between the contents displayed in the at least one grid arranged in the moved at least one row and the contents to be displayed in the at least one grid arranged in the moved at least one row.

The contents corresponding to each of the at least one grid arranged in each of the plurality of rows may be one of text, an image, and a button.

In another aspect of the present invention, a computer-readable recording medium stores a program for performing the method for controlling a grid output in a mobile device.

In another aspect of the present invention, an apparatus for controlling a grid output in a mobile device includes a grid generator for generating a plurality of rows for grids and displaying the generated plurality of rows on a display of the mobile device, a contents output unit for displaying contents corresponding to each of at least one grid arranged in each of the plurality of rows in the grid, a grid mover for sensing movement of a scroll bar, moving the plurality of rows and the contents displayed in each of the at least one grid arranged in the plurality of rows according to the sensed movement of the scroll bar, and moving at least one row that has disappeared from the display due to the movement of the plurality of rows to under a last of a plurality of rows displayed on the display or to above a first of the plurality of rows displayed on the display, a contents converter for changing contents displayed in at least one grid arranged in the at least one row moved to under the last of a plurality of rows displayed on the display or to above the first of the plurality of rows displayed on the display, and a screen output unit for displaying the moved at least one row and the changed contents in the at least one grid arranged in the moved row on the display.

The contents converter may determine whether the contents displayed in the at least one grid arranged in the moved at least one row are identical to contents to be displayed in the at least one grid arranged in the moved at least one row, and if the displayed contents are identical to the contents to be displayed, may maintain the contents displayed in the at least one grid arranged in the moved at least one row.

The contents converter may change only contents corresponding to a difference between the contents displayed in the at least one grid arranged in the moved at least one row and the contents to be displayed in the at least one grid arranged in the moved at least one row.

The contents corresponding to each of the at least one grid arranged in each of the plurality of rows may be one of text, an image, and a button.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a mobile device having an apparatus for controlling a grid output according to an embodiment of the present invention;

FIG. 2 is a block diagram of an apparatus for controlling a grid output in a mobile device according to an embodiment of the present invention;

FIG. 3 is a flowchart illustrating a method for controlling a grid output according to an embodiment of the present invention;

FIG. 4 illustrates a first screen displaying grids on a display unit; and

FIG. 5 illustrates a second screen displaying grids on a display unit.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned. The terms “unit”, “part” and “module” used herein indicate a unit that executes at least one function or operation and may be implemented in hardware, software, or both.

In embodiments of the present invention, each component, function block, or means may be configured with one or more sub-components. Electrical, electronic, and mechanical functions performed by each component may be implemented into various known devices or mechanical elements such as electronic circuits, integrated circuits, or Application Specific Integrated Circuits (ASICs). Components may be configured separately or two or more components may be incorporated into a single component.

Combinations of blocks in the attached block diagrams and steps in the attached flowchart may be performed by computer program instructions. Since these computer program instructions may be loaded on a processor of a mobile device such as a smartphone, instructions performed by a processor of data processing equipment generate a means for performing functions described in each block or step in the block diagrams or flowchart which will be described below.

In addition, each block or each step may represent a part of a module, segment, or code that contains one or more executable instructions to execute a specific logical function(s). It is to be noted that functions mentioned in blocks or steps take place in a different order in some alternative embodiments. For example, two consecutive blocks or steps may be performed substantially at the same or in reverse order depending on corresponding functions.

With reference to the attached drawings, an apparatus and method for controlling a grid output in a mobile device according to embodiments of the present invention will be described below in detail.

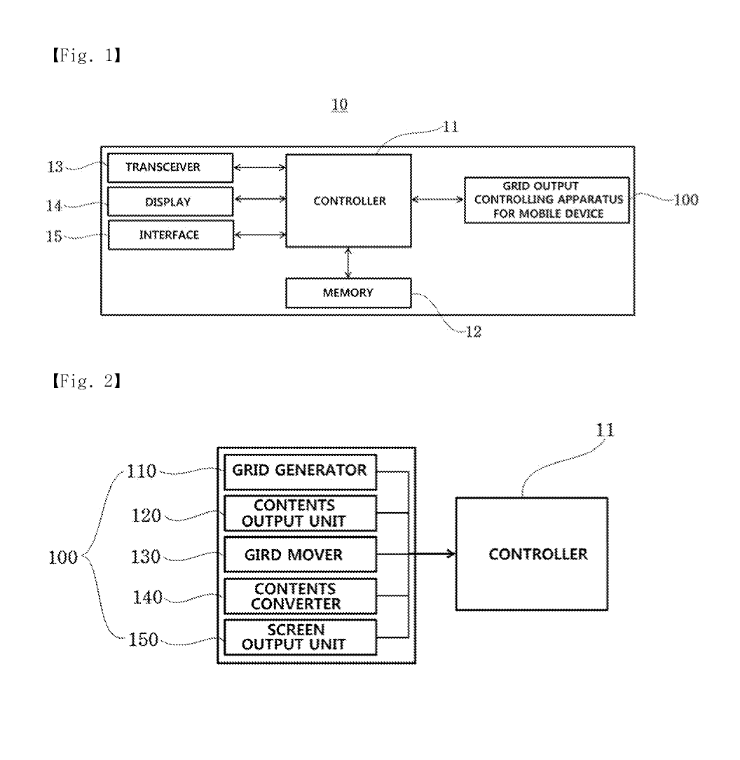

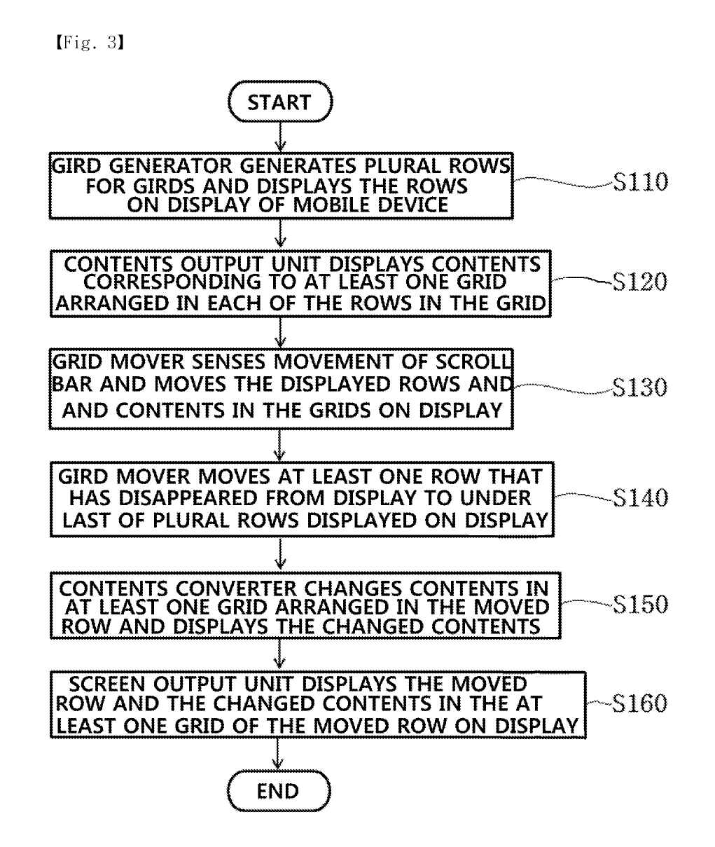

FIG. 1 is a block diagram of a mobile device 10 having a grid output controlling apparatus 100 according to an embodiment of the present invention, and FIG. 2 is a block diagram of the grid output controlling apparatus 100 for a mobile device according to the embodiment of the present invention.

Referring to FIGS. 1 and 2, the mobile device 10 enables a user to view various types of information provided by a Web server by connecting to the Internet. The mobile device 10 may be a device having communication capabilities, such as a smartphone, a tablet Personal Computer (PC), or the like. The mobile device 10 may include a controller 11 that provides overall control to the mobile device 10, a memory 12 that is electrically connected to the controller 11 and stores grid information received from a Web server, a transceiver 13 that is electrically connected to the controller 11 and transmits and receives specific information to and from the Web server, a display 14 that is electrically connected to the controller 11 and displays information received from the Web server and grids generated from the later-described grid output controlling apparatus 100, and an interface 15 that is electrically connected to the controller 11 and serves as an input means.

The grid output controlling apparatus 100 for a mobile device may be electrically connected to the controller of the mobile device 10. The grid output controlling apparatus 100 may receive the grid information stored in the memory 12 from the controller 11, generate grids using the grid information, and display the generated grids on the display 14. The grid output controlling apparatus 100 may also move a plurality of rows of the grids displayed on the display 14 in correspondence with movement of a scroll bar.

The grid output controlling apparatus 100 may include a grid generator 110, a contents output unit 120, a grid mover 130, a contents converter 140, and a screen output unit 150.

The grid generator 110 may generate a plurality of rows for grids based on the grid information received from the controller 11 and display the plurality of rows on the display 14 of the mobile device 10.

The contents output unit 120 may display contents corresponding to at least one grid arranged in each of the plurality of rows displayed on the display 14 in the at least one grid, using the grid information received from the controller 11.

The grid mover 130 may move the plurality of rows for grids in one direction by sensing movement of the scroll bar disposed at at least one side of the grids displayed on the display 14. The grid mover 130 may also move at least one of rows which have disappeared from the display 14 due to the movement of the plurality of rows in the direction to under a last one of a plurality of rows displayed on the display 14. A method for moving a plurality of rows for grids will be described in detail in relation to a method for controlling a grid output according to an embodiment of the present invention.

The contents converter 140 may change contents corresponding to at least one grid arranged in the row that has been moved to under the last of the plurality of rows displayed on the display 14 by the grid mover 130.

The screen output unit 150 may display the row which has been moved by the grid mover 130 and the contents of the at least one grid arranged in the moved row, which have been changed or maintained by the contents converter 140 on the display 14.

Now a detailed description will be given of a method for outputting a grid on the display 14 of the mobile device 10 with reference to FIG. 3. FIG. 3 is a flowchart illustrating a method for controlling a grid output according to an embodiment of the present invention.

Referring to FIG. 3, the grid generator 110 generates a plurality of rows for grids and displays the plurality of rows on the display 14 of the mobile device 10 (S110). Herein, the mobile device 10 may receive grid information from a Web server and store the received grid information in the memory 12. The grid generator 110 may receive the grid information from the controller 11 of the mobile device 10, generate only a predetermined number of rows matching to a screen size of the display 14 from among total rows and contents corresponding to grids arranged in the total rows, and display the generated rows on the display 14. For example, if the grid information includes a total of 15 rows and 10 rows are displayed for grids on a screen of the display 14, the grid generator 110 may generate only first to tenth rows matching to the screen size of the display 14 from among the total rows and display the 10 rows on the display 14 (see FIG. 4). The grids may be outlined in various colors. Or the outlines of the grids may be transparent.

Subsequently, the contents output unit 120 displays contents corresponding to at least one grid arranged in each of the plurality of rows in the at least one grid (S120). Contents corresponding to each grid may be one of text, an image, and a button, which should not be construed as limiting the present invention (see FIG. 4).

The grid mover 130 senses movement of a scroll bar and moves the plurality of rows and the contents displayed in the at least one grid arranged in each of the plurality of rows on the display 14 based on the sensed movement of the scroll bar (S130). The grid mover 130 may determine how much to move the plurality of rows and the contents displayed in the grids arranged in the plurality of rows based on a distance for which the scroll bar has moved. As the grid mover 130 moves the plurality of rows and the contents displayed in the grids arranged in the plurality of rows on the display 14, a part of the plurality of rows may disappear from the display 14.

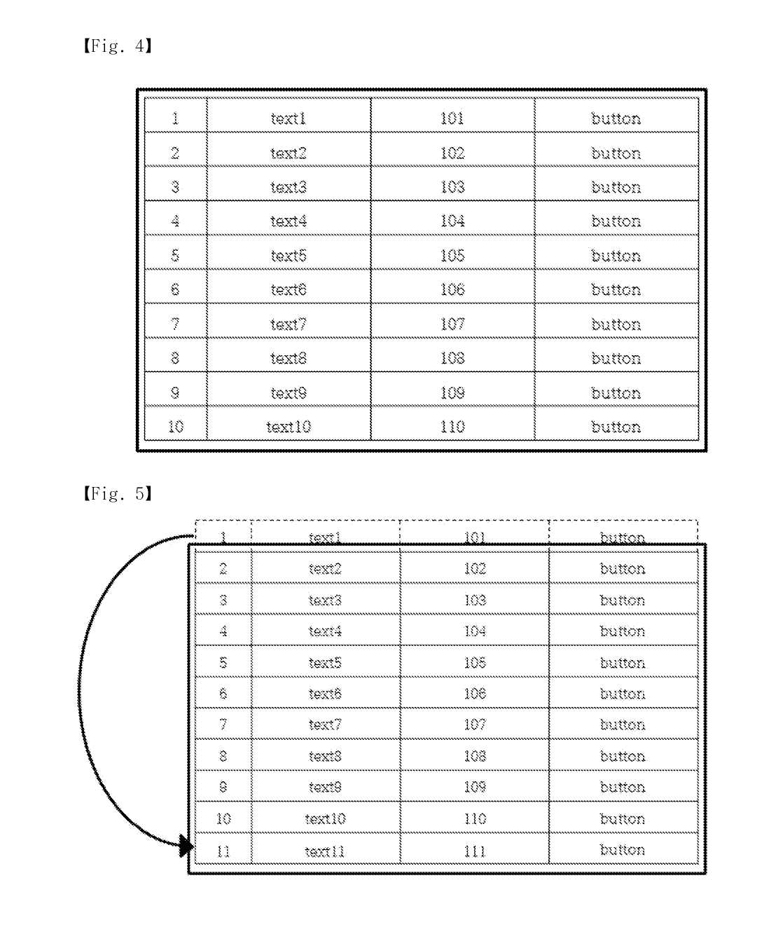

For example, if the grid mover 130 moves up the plurality of displayed rows on the display 14 by a height corresponding to one row, the first of the plurality of rows may disappear from the display 14 (see FIG. 5). If the grid mover 130 moves up the plurality of displayed rows on the display 14 by a height corresponding to two rows, the first and second rows of the plurality of rows may disappear from the display 14. If the first of the plurality of rows is fixed and the grid mover 130 moves up the plurality of rows on the display 14 by a height corresponding to one row, the second row of the plurality of rows may disappear from the display 14.

The same mechanism may apply to the case of moving down the plurality of rows. For example, if the grid mover 130 moves down the plurality of displayed rows on the display by a height corresponding to one row, the last of the plurality of rows may disappear from the display 14. If the grid mover 130 moves down the plurality of displayed rows on the display 14 by a height corresponding to two rows, the last two rows of the plurality of rows may disappear from the display 14. In another embodiment, if the last of the plurality of rows is fixed and the grid mover 130 moves down the plurality of rows on the display 14 by a height corresponding to one row, the last second row of the plurality of rows may disappear from the display 14.

For the convenience of description, the following description will be given in the context that as the grid mover 130 moves up one of rows displayed on the display 14, the first of the rows disappears from the display 14. However, it is to be noted that the same thing applies to the case of moving down the rows.

The grid mover 130 moves at least one of rows that have disappeared from the display 14 to under a last of a plurality of rows displayed on the display 14 (S140). For example, if the first of the rows displayed on the display 14 disappears from the display 14 due to gird movement of the grid mover 130, the gird mover 130 moves the disappearing first row to under the 10^{th} row displayed on the display 14 so that the first row may be eventually used as the 11^{th} row (see FIG. 5).

Since the grid mover 130 moves a row that has disappeared from the display 14 to under the last row displayed on the display 14 instead of discarding the disappearing row, there is no need for generating a new row to be displayed on the display 14 in correspondence with movement of the scroll bar, thus increasing a grid processing speed. Therefore, the method for controlling a grid output according to the embodiment of the present invention can increase the speed of displaying grids on the display 14 of the mobile device 10.

The contents converter 140 changes contents displayed in each of at least one grid arranged in the row moved to under the last row of the plurality of rows (S150). As the first row and the contents of at least one grid arranged in the first row have moved to under the 10^{th} row without any change, it is necessary to change the contents of the at least one grid in the first row according to contents of at least one grid arranged in the 11^{th} row. For example, the contents of the at least one grid in the first row may be replaced with the contents of the at least one grid in the 11^{th} row.

The contents converter 140 may determine whether the contents of the at least one grid arranged in the row that has moved to under the last of the plurality of rows are identical to the replacement contents. If the contents are identical to the replacement contents, the contents converter 140 may maintain the contents. On the other hand, the contents converter 140 may replace only different contents in the at least one grid of the moved row. Since only different contents are replaced rather than the contents of all grids are changed, the method for controlling a grid output according to the embodiment of the present invention can increase the speed of displaying contents in grids.

Finally, the screen output unit 150 displays the row moved by the grid mover 130 and the contents of the at least one grid of the row maintained or changed by the contents converter 140 on the display 14 (S160, see FIG. 5). Accordingly, a new row of grids may be displayed on the display 14 in correspondence with the movement of the scroll bar.

Compared to a conventional grid output method, since only a plurality of rows of grids to be displayed on the display 14 are generated and displayed and a part of disappearing rows resulting from movement of the plurality of rows are reused, the efficiency of a process for displaying rows of grids on the display 14 can be increased.

As is apparent from the above description of the apparatus and method for controlling a grid output according to the embodiments of the present invention, since a row that has disappeared from a display is reused by moving the row to above the first of a plurality of rows displayed on the display or under the last of the plurality of rows, rather than the row is discarded, a plurality of rows of grids can be processed reliably even in a low-performance mobile device.

The proposed method for controlling a grid output in a mobile device may be implemented as computer-readable or smartphone-readable code in a computer-readable or smartphone-readable recording medium. The computer-readable or smartphone-readable recording medium may include any kind of recording device storing computer-readable or smartphone-readable data. Examples of the recording medium may include Read Only Memory (ROM), Random Access Memory (RAM), Compact Disk (CD), Digital Versatile Disk (DVD), Blu-ray disk, magnetic tape, floppy disk, optical data storing device, flash memory, and the like, and may also include the medium that is implemented in the form of carrier waves (for example, transmission over the Internet). In addition, the computer-readable or smartphone-readable recording medium may be distributed over computer systems connected over the network, and computer-readable or smartphone-readable codes may be stored and executed in a distributed manner.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

1. A method for controlling a grid output in a mobile device, the method comprising:
generating a plurality of rows for grids and displaying the generated plurality of rows on a display of the mobile device by a grid generator;
displaying contents corresponding to each of at least one grid arranged in each of the plurality of rows in the grid by a contents output unit;
sensing movement of a scroll bar, moving the plurality of rows and the contents displayed in each of the at least one grid arranged in the plurality of rows according to the sensed movement of the scroll bar, and moving at least one row that has disappeared from the display due to the movement of the plurality of rows to under a last of a plurality of rows displayed on the display or to above a first of the plurality of rows displayed on the display by a grid mover;
changing contents displayed in at least one grid arranged in the at least one row moved to under the last of a plurality of rows displayed on the display or to above the first of the plurality of rows displayed on the display by a contents converter; and
displaying the moved at least one row and the changed contents in the at least one grid arranged in the moved row on the display by a screen output unit.

2. The method according to claim 1, wherein the changing of contents comprises:
determining whether the contents displayed in the at least one grid arranged in the moved at least one row are identical to contents to be displayed in the at least one grid arranged in the moved at least one row; and
maintaining the contents displayed in the at least one grid arranged in the moved at least one row, if the displayed contents are identical to the contents to be displayed.

3. The method according to claim 2, wherein the changing of contents further comprises changing only contents corresponding to a difference between the contents displayed in the at least one grid arranged in the moved at least one row and the contents to be displayed in the at least one grid arranged in the moved at least one row.

4. The method according to claim 1, wherein the contents corresponding to each of the at least one grid arranged in each of the plurality of rows are one of text, an image, and a button.

5. A computer-readable recording medium storing a program for performing the method according to claim 1.

6. An apparatus for controlling a grid output in a mobile device, the apparatus comprising:
a grid generator for generating a plurality of rows for grids and displaying the generated plurality of rows on a display of the mobile device;
a contents output unit for displaying contents corresponding to each of at least one grid arranged in each of the plurality of rows in the grid;
a grid mover for sensing movement of a scroll bar, moving the plurality of rows and the contents displayed in each of the at least one grid arranged in the plurality of rows according to the sensed movement of the scroll bar, and moving at least one row that has disappeared from the display due to the movement of the plurality of rows to under a last of a plurality of rows displayed on the display or to above a first of the plurality of rows displayed on the display;
a contents converter for changing contents displayed in at least one grid arranged in the at least one row moved to under the last of a plurality of rows displayed on the display or to above the first of the plurality of rows displayed on the display; and
a screen output unit for displaying the moved at least one row and the changed contents in the at least one grid arranged in the moved row on the display.

7. The apparatus according to claim 6, wherein the contents converter determines whether the contents displayed in the at least one grid arranged in the moved at least one row are identical to contents to be displayed in the at least one grid arranged in the moved at least one row, and if the displayed contents are identical to the contents to be displayed, maintains the contents displayed in the at least one grid arranged in the moved at least one row.

8. The apparatus according to claim 7, wherein the contents converter changes only contents corresponding to a difference between the contents displayed in the at least one grid arranged in the moved at least one row and the contents to be displayed in the at least one grid arranged in the moved at least one row.

9. The apparatus according to claim 6, wherein the contents corresponding to each of the at least one grid arranged in each of the plurality of rows are one of text, an image, and a button.

10. A computer-readable recording medium storing a program for performing the method according to claim 2.

11. A computer-readable recording medium storing a program for performing the method according to claim 3.

12. A computer-readable recording medium storing a program for performing the method according to claim 4.
